(19) United States
(12) Patent Application Publication
(10) Pub. No.: US 2021/0282375 A1
(43) Pub. Date: Sep. 16, 2021

(54) ANIMAL GUIDING DEVICE

(71) Applicant: LUXSHARE-ICT CO., LTD., Taipei City (TW)

(72) Inventors: Hsin-Nan CHEN, Taipei City (TW); Tsung-Pao HSU, Taipei City (TW); Jung-Pin CHIEN, Taipei City (TW); Yao-Chun TSAI, Taipei City (TW)

(73) Assignee: LUXSHARE-ICT CO., LTD., Taipei City (TW)

(21) Appl. No.: 16/923,710

(22) Filed: Jul. 8, 2020

(30) Foreign Application Priority Data
Mar. 13, 2020 (TW) 109108500

(51) Int. Cl. A01K 27/00; A01K 11/00; A01K 29/00

(52) U.S. Cl. CPC A01K 27/009; A01K 27/006; A01K 29/005; A01K 11/008

(57) ABSTRACT

The present disclosure provides an animal guiding device adapted to be disposed on an animal. The animal guiding device comprises a substrate, an odor module, and a control module. The substrate is adapted to be disposed on the animal. The odor module is disposed on the substrate. The odor module comprises an odor source, an atomizer, and a guide tube. The atomizer atomizes the odor source into an odor gas. The guide tube receives the odor gas from the atomizer. The control module is disposed on the substrate. The control module controls the guide tube to spray the odor gas towards a specified direction.

### CROSS REFERENCE TO RELATED APPLICATION

This application claims the priority benefit of Taiwanese Patent Application Serial Number TW109108500, filed on Mar. 13, 2020, the full disclosure of which is incorporated herein by reference.

### BACKGROUND

### Technical Field

The present disclosure relates to the technical field of guiding technology, particularly to an animal guiding device.

### Related Art

Since a large number of wild animals are hunted and as well the environmental changes, many species of them are now sitting on the verge of extinction. So, the conservation to wild animals has been put into practice, in which observations and guiding of the wild animals are crucial. Conventional wearable devices or guiding devices for animals are only equipped with communication and positioning functions, lacking the functions of assisting animals for food searching and danger avoiding. Another reason that wild animals being endangered is that it is difficult to find a male or female to mate with and to breed. Therefore, proper guidance would greatly improve the survival rate of wild animals.

### SUMMARY

The embodiments of the present disclosure provide an animal guiding device adapted to be disposed on an animal. The animal guiding device comprises a substrate, an odor module, and a control module. The substrate is adapted to be disposed on the animal. The odor module is disposed at the substrate, comprising an odor source, an atomizer, and a guide tube. The atomizer atomizes the odor source into an odor gas. The guide tube receives the odor gas from the atomizer. The control module is disposed on the substrate and is controlling the guide tube to spray the odor gas towards a specified direction.

In some embodiments, the number of guide tubes is plural. The plurality of guide tubes is respectively arranged towards different directions. The control module controls at least one of the guide tubes to spray the odor gas.

In some embodiments, the guide tube comprises a rotating part. The control module controls the rotating part to make the rotating part rotate the guide tube towards the specified direction. The control module makes the guide tube spray the odor gas.

In some embodiments, the animal guiding device further comprises a sound wave module disposed at the substrate, which comprises a sound wave generating device and a bone conduction device. The sound wave generating device generates a sound wave. The bone conduction device converts the sound wave into a shock wave. The control module controls the bone conduction device to output the shock wave to a skull of the animal to simulate the sound from the specified direction.

In some embodiments, the control module controls the bone conduction device to output the shock wave to a first internal ear of the animal. The control module controls the bone conduction device to output the same shock wave to a second internal ear of the animal at a different time.

In some embodiments, the animal guiding device further comprises a light projecting module disposed at the substrate, which comprises a light generating device and a light projecting device. The light generating device generates a light source. The light projecting device receives light of the light source from the light generating device. The control module controls the light projecting device to project the light source towards the specified direction.

In some embodiments, the light source is a light spot or an optical image.

In some embodiments, the number of light projecting devices is plural. The plurality of light projecting devices is respectively disposed towards different specified directions. The control module controls at least one of the plurality of light projecting devices to project the light source.

In some embodiments, the light projecting device comprises a rotating part. The control module controls the rotating part to make the rotating part rotate the light projecting device to the specified direction, and the control module makes the light projecting device project the light source.

In some embodiments, the animal guiding device further comprises an ultrasonic wave module disposed at the substrate, which comprises an environment detection circuit. The environment detection circuit generates an ultrasonic wave to detect the environment around the animal. The control module controls the environment detection circuit to output the ultrasonic wave to the environment of the animal.

In some embodiments, the animal guiding device further comprises a communication module and an ultrasonic wave module. The communication module is disposed at the substrate. The ultrasonic wave module is disposed at the substrate, comprising a sensing circuit sensing the animal to generate a physiological signal. The control module outputs the physiological signal through the communication module.

In some embodiments, the animal guiding device further comprises a communication module and a positioning module. The communication module is disposed at the substrate. The positioning module is disposed at the substrate, generating a positioning signal based on a position of the animal. The control module outputs the positioning signal through the communication module.

Therefore, in some embodiments of the present disclosure, the animal guiding device is disposed on an animal by a substrate; therefore, the animal guiding device could guide or change the moving direction of the animal. It increases the survival rate for the animal by helping the animal to forage, avoid danger, and breed by guiding the animal. For example, the animal can be guided by odor, sound, and vision through different types of guiding modules (such as odor module, sound wave module, light projecting module). In addition, the positioning information sent by the animal guiding device can be received by a server to confirm the position and the moving direction of the animal. The moving direction of the animal can also be directed by remote control of the server.

It should be understood, however, that this summary may not contain all aspects and embodiments of the present disclosure, that this summary is not meant to be limiting or restrictive in any manner, and that the disclosure as disclosed herein will be understood by one of ordinary skill in the art to encompass obvious improvements and modifications thereto.

### BRIEF DESCRIPTION OF THE DRAWINGS

The features of the exemplary embodiments believed to be novel and the elements and/or the steps characteristic of the exemplary embodiments are set forth with particularity in the appended claims. The Figures are for illustration purposes only and are not drawn to scale. The exemplary embodiments, both as to organization and method of operation, may best be understood by reference to the detailed description which follows taken in conjunction with the accompanying drawings in which:

FIG. 1 is a block schematic diagram of an animal guiding device of one embodiment of the present disclosure;

FIG. 2 is a block schematic diagram of an odor module of one embodiment of the present disclosure;

FIG. 3 is a block schematic diagram of an animal guiding device of one embodiment of the present disclosure;

FIG. 4 is a block schematic diagram of an animal guiding device of one embodiment of the present disclosure;

FIG. 5 is a block schematic diagram of an animal guiding device of one embodiment of the present disclosure; and

FIG. 6 is a schematic diagram of an animal guiding device of one embodiment of the present disclosure.

### DETAILED DESCRIPTION OF THE EMBODIMENTS

The present disclosure will now be described more fully hereinafter with reference to the accompanying drawings, in which exemplary embodiments of the disclosure are shown. This present disclosure may, however, be embodied in many different forms and should not be construed as limited to the embodiments set forth herein. Rather, these embodiments are provided so that this present disclosure will be thorough and complete, and will fully convey the scope of the present disclosure to those skilled in the art.

Certain terms are used throughout the description and following claims to refer to particular components. As one skilled in the art will appreciate, manufacturers may refer to a component by different names. This document does not intend to distinguish between components that differ in name but function. In the following description and in the claims, the terms “include/including” and “comprise/comprising” are used in an open-ended fashion, and thus should be interpreted as “including but not limited to”. “Substantial/substantially” means, within an acceptable error range, the person skilled in the art may solve the technical problem in a certain error range to achieve the basic technical effect.

The following description is of the best-contemplated mode of carrying out the disclosure. This description is made for the purpose of illustration of the general principles of the disclosure and should not be taken in a limiting sense. The scope of the disclosure is best determined by reference to the appended claims.

Moreover, the terms “include”, “contain”, and any variation thereof are intended to cover a non-exclusive inclusion. Therefore, a process, method, object, or device that includes a series of elements not only includes these elements, but also includes other elements not specified expressly, or may include inherent elements of the process, method, object, or device. If no more limitations are made, an element limited by “include a/an . . . ” does not exclude other same elements existing in the process, the method, the article, or the device which includes the element.

In the following embodiment, the same reference numerals are used to refer to the same or similar elements throughout the disclosure.

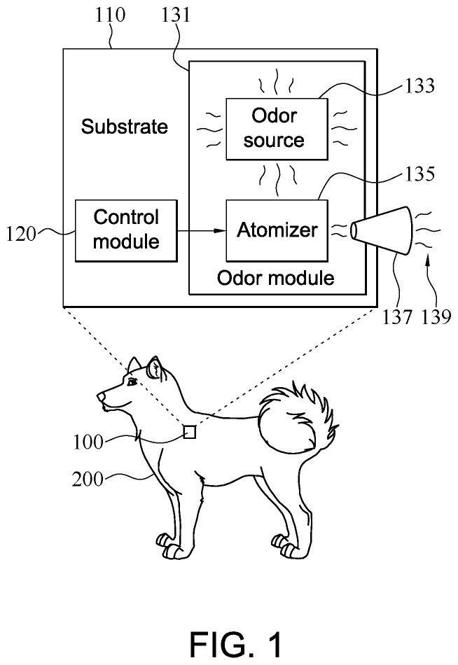

FIG. 1 is a block schematic diagram of an animal guiding device 100 of one embodiment of the present disclosure. An animal guiding device 100 is adapted to be disposed on an animal 200. The animal guiding device 100 comprises a substrate 110, an odor module 131, and a control module 120. The substrate 110 is adapted to be disposed on the animal 200. The odor module 131 is disposed at the substrate 110. The odor module 131 comprises an odor source 133, an atomizer 135, and a guide tube 137. The atomizer 135 atomizes the odor source 133 into an odor gas 139. The guide tube 137 receives the odor gas 139 from the atomizer 135. The control module 120 is disposed on the substrate 110 and controls the guide tube 137 to spray the odor gas 139 towards a specified direction.

The animal guiding device 100 is adapted to guide the moving direction of the animal 200. The foregoing moving direction is, for example, but not limited to, the forwarding direction of the animal 200, such as but not limited to the walking direction, swimming direction, or flying direction. The animal 200 can be but not limited to a mammal, a reptile, a fish, etc. Thus, the control module 120 controls the guide tube 137 to spray the odor gas 139 that the animal 200 likes or dislikes towards the specified direction to guide the animal 200 to move towards a specific direction/position or avoid the specific direction/position. In some embodiments, the animal guiding device 100 can sense the positioning information and physiological information of the animal 200 and return the positioning information and physiological information to a monitoring unit. The monitoring unit is, for example, but not limited to, a computer in a control center or a handheld device of an animal caring staff. The positioning information may be a latitude and longitude coordinates of the animal 200. The physiological information can be the skin pore size change of the animal 200, the vascular fluid flow rate, the skin conductivity, the cortisol concentration, etc. In some embodiments, a positioning module and a sensing circuit (please refer to the embodiments described later) are disposed on the substrate 110 for receiving GPS signals and detecting changes in skin pore size, vascular fluid flow rate, skin conductivity or cortisol concentration. The positioning module and the sensing circuit can be used to generate the described positioning information and physiological information.

The substrate 110 could be a thin film or an electronic skin attached to the skin of the animal 200. The substrate 110 should have good adhesion with the animal 200, so that when the animal 200 moves or shakes, the substrate 110 is not easy to be detached. For example, the substrate 110 could be attached to the backside of the neck or the back of the animal 200. The substrate 110 could also be a wearable device or a part of the wearable device, such as an ankle ring, a collar, or a chest and neck brace, which can be secured to the animal, and the substrate 110 can contact the skin or hair of the animal 200. For example, the substrate 1 110 could be designed as an ankle ring or the substrate 110 may be provided on an ankle ring, and the ankle ring may be worn on the ankle of a bird to make the substrate 110 contact the skin of the ankle or the foot part, but it should not be limited to this. For example, the substrate 110 may be designed as a collar or the substrate 110 may be disposed on the collar, and the collar may be worn on the neck of a cat or a dog, and the substrate 110 may contact the skin and hair of the neck.

The odor module 131 could be an embedded system or an odor detector. The odor source 133 can be or can be simulated to be an item having the odor that the animal 200 likes, such as meat, feces of the same species, or body fluids of the heterosexual species. Or it can be the items having the odor that the animal 200 dislikes, such as vinegar and camphor pills that cats dislike and peppermint oil that mice dislike. The items could be liquids, solids or gases, etc. In some embodiments, the odor module 131 further comprises an odor source storage device for storing the odor source 133. The odor source storage device may be a vacuum container to perfectly preserve the items that generate the odor source 133.

The atomizer 135 could be an ultrasonic wave atomizer, a compressing atomizer, a heating atomizer or a meshed atomizer, etc. The atomizer 135 atomizes the odor source 133 into an odor gas 139. Taking the ultrasonic wave atomizer as an example, the electronic high-frequency oscillation (for example, the oscillation frequency is 1.7 million Hz or 2.4 million Hz) and the high-frequency resonance of the ceramic atomization sheet are used to break up the molecular structure of the odor source 133 to produce tiny particles or molecules that could be fused with the air into an odor gas 139. Taking the compressing atomizer as an example, according to the theory of Venturi's Effect, as the compressed air flows through a small diameter forming a high-speed airflow, the odor source 133 is repeatedly stricken within a barrier to form mist particles, which comes up an odor gas 139. In some embodiments, the odor gas 139 is a gas having the odor of the odor source 133.

The guide tube 137 may be a flexible or non-flexible tube made of steel material, polyvinyl chloride (PVC) material, etc. In some embodiments, the shape of the guide tube 137 could be a cylinder, a triangular cylinder, a cone, etc., but it is not limited to this. In some embodiments, the guide tube 137 has an injection device, such as a pump (e.g., a volumetric pump, a power pump, an electromagnetic pump, a peristaltic pump). After increasing the pressure through compressing the gas, the odor gas 139 is delivered and sprayed through a mechanical device. Thus, when the guide tube 137 is controlled by the control module 120, the odor gas 139 can be sprayed outward (outside the animal guiding device 100) to guide the animal 200.

The control module 120 is, for example, but not limited to, a central processing unit (CPU), or other programmable general-purpose or special-purpose microprocessor, digital signal processor (DSP), programmable controller, application specific integrated circuit (ASIC), etc. In some embodiments, the control module 120 is electrically connected to the odor module 131. In some embodiments, the control module 120 is connected to the odor module 131 via a BUS. The control module 120 is disposed on the substrate 110 and controls the guide tube 137 to spray the odor gas 139 towards a specified direction. For example, the control module 120 sends a control signal to the odor module 131 to actuate the atomizer 135 to atomize the odor source 133 into the odor gas 139, and also to actuate the guide tube 137 so that the guide tube 137 sprays the odor gas 139 towards the direction specified by the control module 120. For example, the control module 120 controls the guide tube 137 to spray the odor gas 139 toward the front left direction of the animal 200, so that the animal 200 advances toward the front left direction or the animal 200 avoids the front left direction; and the control module 120 controls the guide tube 137 to spray the odor gas 139 toward the front right direction of the animal 200 so that the animal 200 advances toward the front right direction or the animal 200 avoids the front right direction, but it should not be limited to these examples in practice. In some embodiments, the odor source 133 may be an odor preferred by the animal 200. The control module 120 controls the guide tube 137 to spray the odor gas 139 toward the front left direction of the animal 200 for guiding the animal 200 to move toward the front left direction, but in practice, it should not be limited thereto. For example, the odor source 133 could be arranged as an odor that the animal 200 dislikes, and the control module 120 controls the guide tube 137 to spray the odor gas 139 toward the rear right direction to guide the animal 200 moving toward the front left direction.

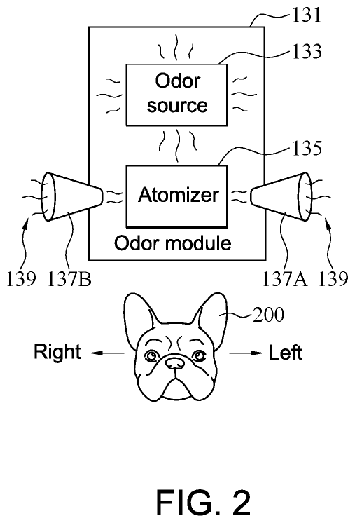

FIG. 2 is a block schematic diagram of an odor module 131 of one embodiment of the present disclosure. In some embodiments, the number of the guide tubes 137A and 137B is plural, and the guide tubes 137A and 137B are respectively arranged towards different directions. The control module 120 controls one or more than one guide tubes 137A and 137B to spray odor gas 139. The guide tubes 137A and 137B are installed towards fixed directions. For example, the outer nozzle (at the outside of the animal guiding device 100 (shown in FIG. 1)) of the guide tube 137A may be provided on the right side of the animal 200, and the outer nozzle of the guide tube 137B may be provided on the left side of the animal 200, but it is not limited thereto. To guide the animal 200 to move towards the right direction, the odor source 133 can be arranged as the odor that the animal 200 likes. The control module 120 (shown in FIG. 1) controls the guide tube 137A to spray the odor gas 139 to guide the animal 200 to move to the right, but it is not limited thereto. For example, the odor source 133 is arranged as an odor that the animal 200 dislikes, the control module 120 controls the guide tube 137B to spray the odor gas 139 to guide the animal 200 to the right.

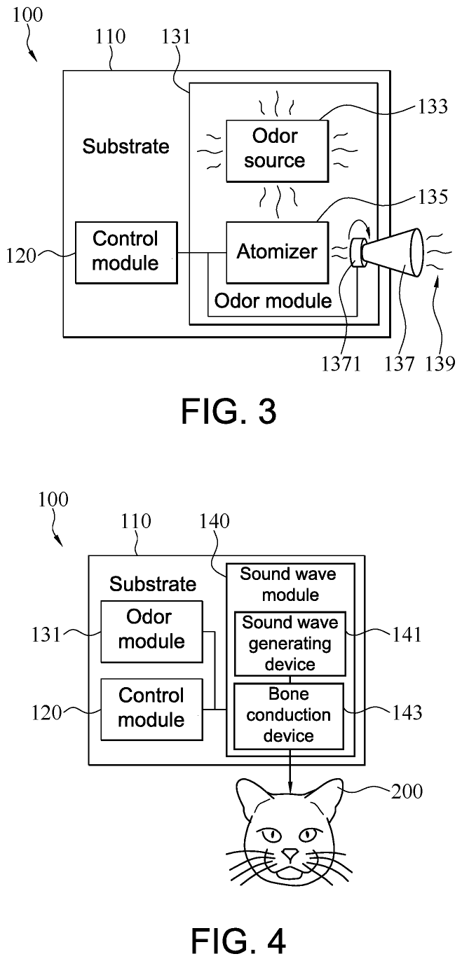

FIG. 3 is a block schematic diagram of an animal guiding device 100 of one embodiment of the present disclosure. In some embodiments, the guide tube 137 comprises a rotating part 1371. The control module 120 controls the rotating part 1371 the rotating part 1371 to rotate the guide tube 137 towards a specified direction, and the control module 120 makes the guide tube 137 spray the odor gas 139. The rotating part 1371 can be a component comprising a gear and a shaft belt, a component comprising a motor, or other mechanical structure that rotates an object, so as to adjust the direction of the guide tube 137 in a 360-degree rotation manner or to swing the guide tube 137 within a certain range of angles. For example, the rotating part 1371 is disposed at the guide tube 137. The control module 120 transmits a control signal to the rotating part 1371 and actuates the rotating part 1371, so that the rotating part 1371 rotates the guide tube 137 to a specified direction. For example, the guide tube 137 can be rotated to the front left of the animal 200. After the guide tube 137 moves to the designated direction, it receives the odor gas 139 from the atomizer 135 and sprays the odor gas 139 to the outside of the animal guiding device 100 to guide the animal 200.

FIG. 4 is a block schematic diagram of an animal guiding device 100 of one embodiment of the present disclosure. In some embodiments, the animal guidance device 100 further comprises a sound wave module 140 disposed at the substrate 110. The sound wave module 140 comprises a sound wave generating device 141 and a bone conduction device 143. The sound wave generating device 141 is used to generate a sound wave. The bone conduction device 143 converts sound waves into a shock wave. The control module 120 controls the bone conduction device 143 to output shock waves to a skull of the animal 200 to simulate the sound coming from the specified direction. In some embodiments, the sound wave module 140 could be an embedded system or an audio module. In some embodiments, the control module 120 is electrically connected to the odor module 131 and the sound wave module 140. In some embodiments, the control module 120 is connected to the odor module 131 and the sound wave module 140 via a BUS connection.

In some embodiments, the sound wave generating device 141 may be a signal generator or a device including a sound wave speaker, etc. The sound wave generating device 141 may comprise a sound wave encoder and a sound wave amplifier. The sound wave encoder converts the sound source file that needs to be played into a sound source signal and sends it to the sound wave amplifier to amplify the sound source signal or to convert an amplified sound source signal into a sound wave through a sound wave speaker. The sound wave encoder and the sound wave amplifier can be computer readable instructions such as program modules that can be executed in a computing device (such as a central processing unit (CPU)). In some embodiments, program modules may be, but not limited to, routines, applications, objects, components, or data structures, which can perform specific tasks or implement specific abstract data types. In some embodiments, the audio signal may be an audio-electro signal.

In some embodiments, the bone conduction device 143 may be an electromagnetic bone conductor, a piezoelectric bone conductor, a device with a vibration motor, a vibrator, a device capable of converting sound waves into mechanical vibration, etc. The bone conduction device 143 receives sound waves from the sound wave generating device 141, generates corresponding sound source signals according to the sound waves, and generate vibration waves corresponding to the sound source signals through the vibrator (piezoelectric vibrator or electromagnetic vibrator) according to the sound source signal. The piezoelectric vibrators can apply an alternating electric field to piezoelectric materials and produce stretching vibrations on piezoelectric materials through the piezoelectric effect to form shock waves. Piezoelectric materials can be piezoelectric single crystal, piezoelectric polycrystal (piezoelectric ceramic), piezoelectric polymer, piezoelectric composite materials, etc. The electromagnetic vibrator can be used to apply a magnetic field to the diaphragm (such as an iron coil or electrostatic diaphragm) to form a shock wave. In some embodiments, the sound wave generating device 141 may be used to generate a sound source signal corresponding to the sound wave, and the bone conduction device 143 receives the sound source signal and generates a shock wave through the vibrator.

The control module 120 controls the bone conduction device 143 to output shock waves to a skull of the animal 200 to simulate sound from a specified direction. For example, the animal 200 can determine the direction of the sound according to the time difference, sound intensity difference, phase difference, timbre difference between the left and right ears. For example, if the animal hears the sound from the left ear first, the animal 200 would determine that the sound comes from the left. When the animal hears the sound from the left louder than that from the right ear, it would possibly think that the sound comes from the left. If the sound comes from the front, the loudness and time of the sound heard by the left and right ears would be identical. The control module 120 controls the bone conduction device 143 to transmit the shock wave to the left and right cochlea of the animal 200 through the skull of the head of the animal 200 to simulate the sound from the specified direction. For example, the control module 120 controls the bone conduction device 143 to output a shock wave with larger amplitude to the cochlea of the left inner ear of the animal 200 and controls the bone conduction device 143 to output a shock wave with smaller amplitude to the cochlea of the right inner ear of the animal 200. Since the sound on the left of the animal 200 is louder than that of the right, it could be judged that the sound comes from the left, then the animal 200 is guided toward the left. For example, if the loudness of a calling sound from the same species heard by the left cochlea of the animal 200 is greater than that by the right cochlea, the animal 200 may be guided to the left, but it is not limited thereto. For example, if the loudness of a harsh sound heard by the right cochlea is greater than that by the left cochlea, the animal 200 may be guided toward the left.

In some embodiments, the control module 120 controls the bone conduction device 143 to output shock waves to a first inner ear of the animal 200 and controls the bone conduction device 143 to output the same shock waves to a second inner ear of the animal 200 at a different time. For example, the control module 120 controls the bone conduction device 143 to output shock waves to the cochlea of the left inner ear of the animal 200 and controls the bone conduction device 143 to output the same shock waves to the cochlea of the right inner ear of the animal 200 at a relatively later time. Since the animal first hears the sound generated by the shock wave on the left cochlea, it can be judged a sound on the left, thus the animal 200 is guided toward the left. For example, the animal 200 hears a calling sound from the same species via the shock wave on the left cochlea earlier than on the right cochlea, so the animal 200 is guided to the left, but it is not limited thereto. For example, the animal 200 hears a harsh sound via a shock wave on the right cochlea earlier than on the left cochlea, thereby guiding the animal 200 to the left. In some embodiments, the bone conduction device 143 outputs sound that can attract animal 200, such as but not limited to the simulated sound of the same species that animal 200 and can interpret as a friendly sound, guiding the animal 200 to move towards the direction to the sound. In some embodiments, the bone conduction device 143 can output a sound that drives the animal 200, such as but not limited to a warning sound that simulates a sound of a natural enemy of the animal 200 or a large predator, so the animal 200 moves away from the coming direction of the sound.

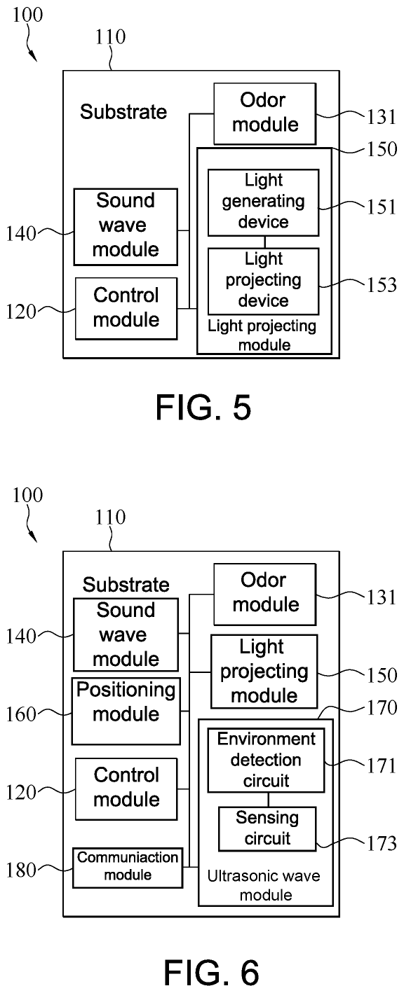

FIG. 5 is a block schematic diagram of an animal guiding device of one embodiment of the present disclosure. In some embodiments, the animal guiding device 100 further comprises a light projecting module 150 disposed at the substrate 110. The light projecting module 150 comprises a light generating device 151 and a light projecting device 153. The light generating device 151 generates a light source. The light projecting device 153 receives light of the light source from the light generating device 151. The control module 120 controls the light projecting device 153 to project the light source towards a specified direction. In some embodiments, the light projecting module 150 may be an embedded system, a projector, a laser device, etc. In some embodiments, the control module 120 is electrically connected to the odor module 131, the sound wave module 140, and the light projecting module 150. In some embodiments, the control module 120 is connected to the odor module 131, the sound wave module 140, and the light projecting module 150 via a BUS connection. The light generating device 151 is, for example, but not limited to, a light emitting diode (LED), a device that converts a digital signal into an optical image, a laser emitter, etc. The light projecting device 153 is, for example, but not limited to, a spotlight. In some embodiments, the light source is a light spot (such as a laser light spot) or an optical image (such as a projection mapping or a holographic image).

The control module 120 controls the light projecting device 153 to project the light source towards a specified direction. As we know, cats like to chase light spots. When the control module 120 controls the light projecting device 153 to project the light spot to the front left of the cat, it guides the cat to move toward to the front left. For another example, the control module 120 controls the light projecting device 153 to project a light sculpture image or a holographic image of the female animal 200 of the same species toward the front left of the male animal 200 to guide the male animal 200 to move toward the front left.

In some embodiments, the number of light projecting device 153 is plural. The light projecting devices 153 are respectively arranged towards different directions. The control module 120 controls at least one of the plurality of light projecting devices 153 to project the light source. For example, the directions of the light projecting devices 153 are fixed. For example, the projecting terminal of a light projecting device 153 facing the outside (outside of the animal guiding device 100) is disposed at the right side of the animal 200, and the projecting terminal of another light projecting device 153 facing the outside is disposed at the left side of the animal 200, but it is not limited thereto. To guide the animal 200 to move to the right, the control module 120 can output a control signal to actuate the light projecting device 153 provided on the right side of the animal 200 to project a food image, but it is not limited thereto.

In some embodiments, the light projection device 153 comprises a rotating part. The control module 120 controls the rotating part to make the rotating part rotate the light projecting device 153 towards a specified direction, and the control module 120 makes the light projecting device 153 project a light source. The rotating part could be a component similar to the rotating part 1371 of the odor module 131 of the foregoing embodiment. For example, the rotating part is disposed at the light projecting device 153. The control module 120 transmits a control signal to the rotating part and actuates the rotating part. So that the rotating part rotates the light projecting device 153 towards a specified direction. For example, the rotating part rotates the light projecting device 153 to face the front left of the animal 200. After the light projecting device 153 moves to face a specified direction, it receives the light source from the light generating device 151 and projects the light source to the outside of the animal guiding device 100 to guide the animal 200.

FIG. 6 is a schematic diagram of an animal guiding device of one embodiment of the present disclosure. In some embodiments, the animal guiding device 100 further comprises an ultrasonic wave module 170, a communication module 180, and a positioning module 160. In some embodiments, the animal guiding device 100 further comprises one or two of the ultrasonic wave module 170, the communication module 180, or the positioning module 160. The ultrasonic wave module 170, the communication module 180, and the positioning module 160 are all disposed at the substrate 110. The ultrasonic wave module 170 comprises an environment detection circuit 171 and a sensing circuit 173. The environment detection circuit 171 generates an ultrasonic wave to detect the environment around the animal 200, wherein the control module 120 controls the environment detection circuit 171 to output ultrasonic waves to the environment around the animal 200. The sensing circuit 173 senses the animal 200 to generate a physiological signal, wherein the control module 120 outputs the physiological signal through the communication module 180. The positioning module 160 generates a positioning signal according to a position of the animal 200, and the control module 120 outputs the positioning signal through the communication module 180. The position of the animal 200 could be a latitude and longitude coordinate of the animal 200.

In some embodiments, the control module 120 is electrically connected to the odor module 131, the sound wave module 140, the light projection module 150, the ultrasonic wave module 170, the communication module 180, and the positioning module 160. In some embodiments, the control module 120 is connected to the odor module 131, the sound wave module 140, the light projection module 150, the ultrasonic wave module 170, the communication module 180, and the positioning module 160 via a BUS connection. In some embodiments, the control module 120 outputs a positioning signal and a physiological signal to an external device (to be described in detail later) through the communication module 180. The external device may be, but not limited to, a server, a microprocessor, a computer, a cloud drive, etc. To facilitate the explanation of the relationship between the external device and the animal guiding device 100, the external device would be referred to as “server” hereinafter.

The ultrasonic wave module 170 may be, but is not limited to, the sound wave ranging module. The communication module 180 could be a wireless transmission communication module 180, such as but not limited to Bluetooth, wireless hotspot Wi-Fi, or mobile communication, or could be a wired transmission communication module 180, such as but not limited to Ethernet or universal serial bus (USB). The positioning module 160 could be, but not limited to, a satellite positioning module or a global positioning (GPS) module. The positioning signal may be a communication signal containing positioning information of the animal 200. The physiological signal is, but not limited to, signals generated by sensing a skin pore size, a change of the skin pore size, a vascular fluid flow rate, and/or a change of the vascular fluid flow rate of an animal 200 through the sensing circuit 173 of the ultrasonic wave module 170 when the animal guiding device 100 contacts the animal 200. The environment detection circuit 171 and the sensing circuit 173 could be a computer readable instruction such as a program module that can be executed by the computing device (such as a central processing unit, CPU), or could be a circuit performing specific functions.

The control module 120 controls the environment detection circuit 171 to output ultrasonic waves to the environment around the animal 200 to detect the environment around the animal 200. For example, the environment detection circuit 171 detects the environment around the animal 200 at a 360 degree angle. When a dangerous object (such as a cliff, a hunter hunting animals 200, or an obstacle) is incoming, the control module 120 controls at least one of the odor module 131, the sound wave module 140 or the light projecting module 150 to keep the animal 200 away from those dangers by proper guiding.

The sensing circuit 173 senses the animal 200 to generate a physiological signal. For example, the sensing circuit 173 applies an ultrasonic wave to sense a skin pore size, a change of the skin pore size, a vascular fluid flow rate, or a change of vascular fluid flow rate to generate a physiological signal. Since the ultrasonic wave is penetrative and is not disturbed by any light, the sensing circuit 173 emits ultrasonic waves, and the animal 200 can be sensed based on the Doppler Effect of the wave. The frequency of the reflected ultrasonic wave changes when the object moves. The frequency increases as the object moves towards the receiver of the sensing circuit 173, and, in contrast, the frequency decreases as the object moves away. From the change of the frequency of the echo, the sensing circuit 173 can calculate the moving speed of the object. Based on this, the changes in the skin pore size and the flow rate of the vascular fluid of the animal 200 can be obtained to generate physiological signals. In some embodiments, the sensing circuit 173 can sense the changes of the skin pore size of the animal 200 and the flow rate of the vascular fluid from different angles to generate multiple 2D ultrasonic wave images and to obtain a 3D image with external computer generated imagery technology. Based on the physiological signals such as changes of the skin pore size or the flow rate of the vascular fluid of the animal 200, the server is able to determine the physiological and emotional state of the animal 200, such as the physical state, the response to the environment, the stress, or the emotional changes.

In some embodiments, the control module 120 transmits control signals to control the odor module 131, the sound wave module 140, the light projecting module 150, the ultrasonic wave module 170, the communication module 180, and the positioning module 160. The control signal is, but not limited to, an electrical signal, a serial signal, a level signal, etc.

In some embodiments, the control module 120 of the animal guidance device 100 may control only one, two, or all of the odor module 131, the sound wave module 140, or the light projecting module 150 to guide the animal 200 toward the specified direction. In some embodiments, since the control module 120 can selectively control the odor module 131, the acoustic wave module 140 and/or the light projection module 150, the animal guiding device 100 could only be provided with one or both of the odor module 131, the sound wave module 140 or the light projecting module 150. In some embodiments, multiple guiding methods are used. For example, the odor module 131, the sound wave module 140, and the light projecting module 150 can be used at the same time to improve the guiding accuracy for the animal 200 to move toward a specified direction. In other embodiments, the animal guiding device 100 may not be provided with the positioning module 160. In other embodiments, the ultrasonic wave module 170 may be provided with only the environment detection circuit 171 or only the sensing circuit 173. When only the environment detection circuit 171 is provided, and the animal guiding device 100 is not provided with the positioning module 160, the communication module 180 is not necessary.

In some embodiments, the server receives the positioning signal and the physiological signal and processes the positioning signal and the physiological signal through a computing device to obtain the positioning information and the physiological state of the animal 200. The computing device is but not limited to microprocessors, microcontrollers, digital signal processors, microcomputers, central processors, etc. The Physiological state is, but not limited to, heart rate, stress level, or other indications determining the physiological or emotional condition of the animal.

In some embodiments, the server may cooperate with a plurality of animal guiding devices 100. Each server corresponds to a plurality of animal guiding devices 100, each of the animal guiding devices 100 corresponds to one animal 200. The animal guiding device 100 can automatically return physiological and position data at a predetermined frequency. In addition to real-time monitoring of the current status of the physiological state of the animal 200, the server can also analyze the physiological signal from the animal 200 when the collected samples are sufficient, to obtain short-term or long-term health or active status of the animal 200. When an abnormality of the physiological state of the animal 200 is detected, such as hypoglycemia, the server determines that the animal is in hunger and sends a controlling command to the animal guiding device 100 to have the animal guiding device 100 guide the animal 200 to move to a close spot with food provided. When a potential danger is detected on the surrounding of the animal 200, the server may send a control command to the animal guiding device 100 on the animal 200 to guide the animal 200 to move away from the danger. In some embodiments, the server could analyze the physiological signals of a plurality of animals 200 wearing animal guiding devices 100 or analyze the physiological signals of a plurality of animals 200 in the same area to realize the physiological signals of the regional animals 200 during a specific time interval. In some embodiments, the server may further combine the physiological signals of the animal 200 in a specific area with weather information (such as temperature, humidity, rainfall, and wind data) to perform correlation analysis.

In summary, embodiments of the present disclosure provide an animal guiding device disposed on an animal by a substrate. The animal guiding device could guide or change the moving direction of animals. The animal guiding device works through a variety of different guiding modules (such as odor module, sound wave module, light projecting module) to guide the animals by, for example, odor, sound, and vision to help the animals to forage, to avoid danger, and to breed, such that the animals have a better chance to survive. In addition, the positioning information sent by the animal guiding device can be received by the server to monitor the positioning and the moving direction of the animal. The animal can also be guided towards specified directions by performing remote control of the server.

It is to be understood that the term “comprises”, “comprising”, or any other variants thereof, is intended to encompass a non-exclusive inclusion, such that a process, method, article, or device of a series of elements not only comprise those elements but also comprises other elements that are not explicitly listed, or elements that are inherent to such a process, method, article, or device. An element defined by the phrase “comprising a . . . ” does not exclude the presence of the same element in the process, method, article, or device that comprises the element.

Although the present disclosure has been explained in relation to its preferred embodiment, it does not intend to limit the present disclosure. It will be apparent to those skilled in the art having regard to this present disclosure that other modifications of the exemplary embodiments beyond those embodiments specifically described here may be made without departing from the spirit of the disclosure. Accordingly, such modifications are considered within the scope of the disclosure as limited solely by the appended claims.

What is claimed is:

1. An animal guiding device adapted to be disposed on an animal, comprising:
a substrate adapted to be disposed on the animal;
an odor module disposed at the substrate, comprising:
an odor source;
an atomizer atomizing the odor source into an odor gas; and
a guide tube receiving the odor gas from the atomizer; and
a control module disposed on the substrate and controlling the guide tube to spray the odor gas towards a specified direction.

2. The animal guiding device according to claim 1, wherein the number of the guide tubes is plural; the plurality of guide tubes are respectively arranged towards different specified directions; the control module controls at least one of the guide tubes to spray the odor gas.

3. The animal guiding device according to claim 1, wherein the guide tube comprises a rotating part; the control module controls the rotating part to make the rotating part rotate the guide tube to the specified direction and makes the guide tube spray the odor gas.

4. The animal guiding device according to claim 1 further comprising:
a sound wave module disposed at the substrate, the sound wave module comprising:
a sound wave generating device generating a sound wave; and
a bone conduction device converting the sound wave into a shock wave;
wherein the control module controls the bone conduction device for outputting the shock wave to a skull of the animal to simulate the sound from the specified direction.

5. The animal guiding device according to claim 4, wherein the control module controls the bone conduction device for outputting the shock wave to a first internal ear of the animal; the control module controls the bone conduction device for outputting the same shock wave to a second internal ear of the animal at a different time.

6. The animal guiding device according to claim 1, further comprising:
a light projecting module disposed at the substrate, comprising:
a light generating device generating a light source; and
a light projecting device receiving light of the light source from the light generating device;
wherein the control module controls the light projecting device to project the light source towards the specified direction.

7. The animal guiding device according to claim 6, wherein the light source is a light spot or an optical image.

8. The animal guiding device according to claim 6, wherein the number of the light projecting devices is plural; the light projecting devices are respectively disposed towards different specified directions; the control module controls at least one of the light projecting devices to project the light source.

9. The animal guiding device according to claim 6, wherein the light projecting device comprises a rotating part; the control module controls the rotating part to make the rotating part rotate the light projecting device to the specified direction and makes the light projecting device project the light source.

10. The animal guiding device according to claim 1, further comprising:
an ultrasonic wave module disposed at the substrate, the ultrasonic wave module comprising an environment detection circuit generating an ultrasonic wave for detecting the environment around the animal;
wherein the control module controls the environment detection circuit for outputting the ultrasonic wave to the environment around the animal.

11. The animal guiding device according to claim 1, further comprising:
a communication module disposed at the substrate; and
an ultrasonic wave module disposed at the substrate, the ultrasonic wave module comprising a sensing circuit for detecting the animal to generate a physiological signal;
wherein the control module outputs the physiological signal through the communication module.

12. The animal guiding device according to claim 1, further comprising:
a communication module disposed at the substrate; and
a positioning module disposed at the substrate, the positioning module being for generating a positioning signal based on a position of the animal;
wherein the control module outputs the positioning signal through the communication module.

13. The animal guiding device according to claim 2, further comprising:
a communication module disposed at the substrate; and
a positioning module disposed at the substrate, the positioning module being for generating a positioning signal based on a position of the animal;
wherein the control module outputs the positioning signal through the communication module.

14. The animal guiding device according to claim 3, further comprising:
a communication module disposed at the substrate; and
a positioning module disposed at the substrate, the positioning module being for generating a positioning signal based on a position of the animal;
wherein the control module outputs the positioning signal through the communication module.

15. The animal guiding device according to claim 4, further comprising:
a communication module disposed at the substrate; and
a positioning module disposed at the substrate, the positioning module being for generating a positioning signal based on a position of the animal;
wherein the control module outputs the positioning signal through the communication module.

16. The animal guiding device according to claim 5, further comprising:
a communication module disposed at the substrate; and
a positioning module disposed at the substrate, the positioning module being for generating a positioning signal based on a position of the animal;
wherein the control module outputs the positioning signal through the communication module.

17. The animal guiding device according to claim 6, further comprising:
a communication module disposed at the substrate; and
a positioning module disposed at the substrate, the positioning module being for generating a positioning signal based on a position of the animal;
wherein the control module outputs the positioning signal through the communication module.

18. The animal guiding device according to claim 7, further comprising:
a communication module disposed at the substrate; and
a positioning module disposed at the substrate, the positioning module being for generating a positioning signal based on a position of the animal;
wherein the control module outputs the positioning signal through the communication module.

19. The animal guiding device according to claim 8, further comprising:
a communication module disposed at the substrate; and
a positioning module disposed at the substrate, the positioning module being for generating a positioning signal based on a position of the animal;
wherein the control module outputs the positioning signal through the communication module.

20. The animal guiding device according to claim 9, further comprising:
a communication module disposed at the substrate; and
a positioning module disposed at the substrate, the positioning module being for generating a positioning signal based on a position of the animal;
wherein the control module outputs the positioning signal through the communication module.
